(19) United States
(12) Patent Application Publication
(10) Pub. No.: US 2003/0033805 A1
(43) Pub. Date: Feb. 20, 2003

(54) Advective solar collector for use in multi-effect water distillation and power production

(76) Inventor: Paul A. LaViolette, Alexandria, VA (US)

Correspondence Address: Paul A. LaViolette, 6369 Beryl Road, #104, Alexandria, VA, 22312, US

(21) Appl. No.: 09/924,134

(22) Filed: Aug. 8, 2001

(51) Int. Cl. B01D 3/10

(52) U.S. Cl. 60/641.8

(57) ABSTRACT

A method and apparatus is described for the multi-effect distillation of water using incident solar energy wherein thermal gradients, established along the length of the still, induce the heat of water condensation to be recuperated to aid feedstock water evaporation. A fan induces air to flow through the still in a closed loop path through transparent plastic film ducts. Air passing through the lower air duct, progressively warms and evaporates feedstock water from the floor of the still. At the hot end of the duct, the airstream passes through an opening into the upper air duct where it passes down the length of the upper air duct in reverses direction, progressively cooling and condensing its vapor on the walls of the still. The heat of condensation conducts to the lower air duct by passing through the light-transmitting plastic film barrier that separates the two air ducts.

### REFERENCES CITED

U.S. Patent Documents

| | | | |
|---|---|---|---|
| 3,317,406 | May 1967 | Beard | 203/10 |
| 3,334,026 | August 1967 | Dobell | 203/10 |
| 3,908,631 | September 1975 | Rom | 126/270 |
| 4,363,703 | December 1982 | ElDifrawl | 203/10 |
| 4,458,673 | July 1984 | Benjamin | 126/443 |

Other references

G. Mink et al. “Design parameters, performance testing and analysis of a double-glazed, air-blown solar still with thermal energy recycle.” Solar Energy, vol. 64, Nos. 4-6, pp. 265-277, 1998.

### BACKGROUND OF THE INVENTION

The Advective Solar Collector (ASC) described in this invention, set forth in provisional disclosure application No. 60/224,002 filed on Aug. 09, 2000, relates to the field of water purification in that it can be applied to distill water into fresh water. It uses solar energy to evaporate water into a ducted airstream and subsequently condenses water from the airstream to produce fresh water. This process may be used in areas where sunlight is available to distill, seawater, brackish well water, or contaminated river water for human consumption and farming. It may also be used to distill effluents from chemical processing plants, paper mills, and sewage treatment plants prior to discharge to the environment. In addition, the ASC solar still may be configured to produce energy as a by-product.

Early solar still designs were of the greenhouse variety. As illustrated in FIG. 1, the prior art greenhouse solar still absorbs solar radiation by means of a horizontal light-absorbing panel which in turn heats an overlying layer of water. The heated water evaporates, the vapor condenses on a cool, inclined window pane that forms the roof of the still, and the condensed droplets run down this pane to collect in a trough. All of the solar energy that is absorbed to evaporate water is discharged to the environment through the roof of the still in order to allow the vapor to condense. Greenhouse solar stills are of the single-effect type which means that they use the incident solar radiation only once to distill a given amount of feedstock water. Stills that recycle the heat of condensation to assist the water evaporation process are instead termed multi-effect stills.

Greenhouse stills generally have a distillation efficiency ranging from 20% to 40%, and are capable of producing up to 0.09 gal/ft²/day, or about 3½ liters (1) per m² per day in summer months. In 1970 Battelle Memorial Institute surveyed single-effect, greenhouse type solar stills that were in operation world wide and concluded that solar distillation was competitive with other methods of distillation (i.e., flash or reverse osmosis processes) only for low capacity plants (under 50,000 gallons/day) where the costs of these other alternatives begin to increase exponentially. The study estimated that large greenhouse solar still installations having areas greater than 1000 ft² had capital costs as low as $1.00/ft² of basin area with water costs between $3.00-$4.00 per 1000 gallons. Updating this to Year 2000 prices, the cost would be about $4.3/ft² with water costs between $13-$17 per 1000 gallons.

Other prior art solar stills use forced air advection to assist water evaporation. Examples include the inventions of Beard (U.S. Pat. No. 3,317,406) and Dobell (U.S. Pat. No. 3,334,026) in which air is blown over solar heated water to assist evaporation, distillate being subsequently recovered by passing the humidified airstream through a condenser. These blown air stills are designed to have their solar heated evaporator section physically separated from their condenser section. Consequently, the heat of condensation that is released in their condenser is almost entirely lost to the environment. Except for a small portion which is recovered to heat the feedstock water that enters the evaporator, most of the heat of condensation is not returned to the evaporator. As an example, one gram of feedstock water preheated in the condenser section might absorb about 40 to 60 calories of heat to be recycled to the evaporator, as compared with 540 calories of heat that are released in the condenser as a result of condensing one gram of water from the advected airstream. Since only about 10% of the heat of condensation is recycled, these feedstock preheater designs essentially function as single-effect stills.

### BRIEF SUMMARY OF THE INVENTION

A key distinguishing feature of the ASC solar still invention is that it establishes a temperature gradient along its length in its interior air space for the purpose of conducting multi-effect water distillation and power generation. Like a conventional flat plate solar collector, the ASC solar still has a solar energy light absorber as its lower surface, preferably black in color, and one or more light-transmitting films or sheets for its upper surface, as illustrated in FIG. 2, FIG. 3 and FIG. 4. But in addition, the still includes a partition that extends horizontally along its length, situated midway between its lower solar absorber surface and its light-transmitting roof so as to divide its interior air space into upper and lower air ducts. The partition is both light-transmitting and sufficiently thin so as to allow heat to transfer at an appreciable rate from the upper to lower air ducts. As one example, this partition may be formed of a transparent plastic film having a thickness in the range of 1 to 8 mils. As in the greenhouse still, feedstock water covers the floor of the still to a depth of up to a few inches.

The still also contains a fan that forces air to circulate along the length of its air ducts. The fan, which is positioned within one of the air ducts preferably at one end of the lower air duct, blows air down the length of the duct. The advected air is heated and humidified through contact with the layer of solar heated water and is also heated through contact with the warm light-transmitting partition above it. This air progressively heats up and becomes saturated with an increasing quantity of water vapor as it passes down the length of the still. Upon reaching the far end of the still, the air passes through a hole in the light-transmitting partition and enters the upper air duct. There, it reverses its flow to proceed back toward the fan end of the still. As it proceeds, it progressively cools, losing heat upward through the light-transmitting roof of the still and downward through the film partition. As this air cools, fresh water condenses onto the walls of the upper duct and this condensate gathers at the edges of the air duct and flows toward the cool end of the still where it is pumped out. Upon reaching the fan end of the still, the air passes through another hole in the light transmitting partition to enter once again the lower air duct, thus circulating in a closed loop.

Because it takes time for the air in the lower air passage to heat up, a thermal gradient is established, both in the air and in the feedstock water, extending along the length of the still, the air and water being coolest at the end where the air enters the lower air passage and hottest at the opposite end. The feedstock water to be distilled is pumped onto the floor of the still preferably at the cool end. Just as there is a time lag in heating as the air flows through the lower air duct, so too there is a time lag in cooling as the air flows through the upper air duct. The air in the upper air duct does not begin to cool immediately since the upper surface of this air duct is insulated from the outside air by one or more light-transmitting films or sheets. Consequently, the temperature gradients in the upper and lower air ducts will be shifted with respect to one another so that the air in the upper duct will be several degrees warmer than the air in the lower duct directly below it, as illustrated in FIG. 5. The temperature differential due to this mismatch causes heat to conduct and radiate through the plastic film barrier from the upper to the lower airstreams. Consequently, a large fraction of the heat of condensation released from the upper airstream is transferred to the lower airstream where it assists the water evaporation process. Thus the ASC operates as a multi-effect solar still. The lower airstream is heated both by contact with the light-transmitting barrier above it and solar heated water surface below it, while the upper airstream is cooled both by contact with the underlying light-transmitting barrier and with the still's overlying light-transmitting roof.

Advecting the air along the length of the ASC still produces greater temperature extremes. For example, the hot end of the still is able to achieve feedstock water temperatures exceeding those normally achieved in a greenhouse still because the horizontal movement of the advected air inhibits the formation of vertical convection currents that normally are a major means of heat loss and also because the upper air duct inhibits the upward loss of heat from the lower air duct. Also at the cool end of the ASC still, the roof of the still will achieve temperatures that are cooler than the window surface temperature normally achieved in a conventional greenhouse still, the solar heated water at the cool end of the still being cooler than the water in a conventional greenhouse still. This greater temperature differential achieved within the ASC still improves the rate at which it distills water.

The great length of the air ducts in the ASC still is another design feature that facilitates the formation of large temperature extremes within the still. Long air ducts are necessary in order to allow sufficient time for the blown air to effect a substantial change of temperature as it absorbs heat in the lower air duct or discharges heat in the upper air duct. Moreover, by dividing the upper and lower air ducts with a thermal exchange partition made from a light-transmitting substance such as plastic film, relatively little heat will be conducted parallel to the film's surface along the length of the collector. This ensures that the walls of the ducts do not easily transfer heat from the hot end of the still to its cool end, thereby allowing maximal temperature extremes to form at either end of the air ducts. Making the floor of the still from a thermally insulating material will similarly retard heat from conducting along the length of the pool of feedstock water.

By locating the condenser air duct above the evaporator air duct and ensuring that the condenser air is warmer than the evaporator air in vertical cross section, the ASC design minimizes upward heat loss from its evaporator chamber. The layer of humid air and film of water condensate in the condenser air duct effectively also retards heat loss by impeding infrared radiation from freely passing upward through the evaporator duct and escaping from the still. By ensuring that the partition between the evaporator and condenser is sufficiently thin, heat from the condenser air duct will flow into the evaporator duct at a significant rate. By also ensuring that this partition is light-transmitting, solar radiation can easily pass downward through the still, penetrating through the condenser air duct to the floor of the still where it assists water evaporation. Since heat escapes from a solar collector most readily through its upper surface, it is more desirable to have the condenser air duct uppermost in the still so that any upward heat loss will aid condensation. The ASC design, minimizes heat loss through the floor of the evaporator duct by placing a layer of insulation beneath the floor of the still and by ensuring that the floor rests on the ground. Heat flowing into the ground becomes stored for night time use, rather than being lost to the environment.

The ASC will establish its greatest temperature differential between its hot and cool ends at an optimal advection velocity, i.e., at an optimal fan speed. This speed depends upon variables such as the cross sectional area of the air passage, the heat capacity of the advected air medium, the rate of solar energy input from the still's light-absorbing floor, and the rate of heat loss to the environment. If the fan speed is too low, the air will attain its upper temperature limit before reaching the end of the lower air duct. If the fan speed is too high, the air arriving at the high-temperature end of the still will not yet have reached its potentially highest temperature.

As an example, imagine a collector of dimensions 1 m×20 m, whose lower air passage has a cross sectional area of 0.3 m², and whose optimal cool and hot temperatures are 40° C. and 85° C. respectively. The heat of vaporization of water is 540 cal/g. At a temperature of 40° C., one cubic meter of air at saturation holds 90 grams of water vapor, whereas at 85° C. this same volume of air is able to hold 735 grams of vapor. Consequently, for one cubic meter of vapor saturated air to rise in temperature from 40° C. to 85° C. and stay 90% saturated by evaporating water, it must absorb about 313 kcal of heat (540 cal/g×645 g×0.9). This is over 50 times the amount required to raise the temperature of an equivalent mass of dry air since the heat capacity for dry air is only about ¼ cal/g/° C.

Suppose that the net noontime rate of solar heat input into the lower airstream is 410 cal/s/m² (1.7 kw/m²). About one-third of this heat is assumed to be supplied by the sun, averaging 0.57 kw/m², and the remaining two-thirds (1.13 kw/m²) is assumed to come from heat of condensation supplied by the upper airstream. Then the 0.3 m³ of air above a square meter of solar absorber will take about 230 seconds to heat from 40° C. to 85° C. when 90% saturated. Since it travels a distance of 20 meters down the length of the still, the air will attain its 85° C. temperature at the end of the tunnel if it flows at a velocity of about 8.7 cm/s (0.28 feet per second). For an air duct cross section of 0.3 m², this would require a fan delivering air at a rate of 53 cfm (or 1.5 m³/min). Since the air temperature, on return, drops from 85° C. to 40° C., 0.58 liters of water may be recovered from each cubic meter of air. Consequently, at midday, water may be condensed from this airstream at the rate of 54 l/hr (0.58 l/m³×1.55 m³/min)×60 min/hr) or 2.7 l/hr/m². Multiplying this by an effective 8 hour day of operation, the ASC still would theoretically be able to distill water at the rate of 22 liters per day per square meter of still area at a cost of $4.50 per 1000 gallons. It would distill water at over six times the rate of a greenhouse solar still and at about one-third of the price. It is able to produce distilled water at a cost sufficiently low as to make it competitive with alternative methods of distillation such as reverse osmosis membrane technologies.

Higher fan speeds will transport air and vapor at a greater rate through the still but will also tend to reduce the magnitude of the still's lengthwise thermal gradient which, in turn, will reduce the amount of water vapor present in each cubic meter of air. So, increasing fan speed too far will result in a decreased rate of water distillation. Since incident solar radiation and ambient air temperature change with time of day and season, an optimal thermal gradient along the length of the still could be maintained by varying the fan speed accordingly. One type of control circuit that might do this would use a timer to change the fan speed for various times of the day or night and would incorporate additional seasonal settings to tailor the speed to the time of the year. If multiple fans are used to advect air down the length of the still, the control circuit might instead regulate the number of fans that are in operation at any one time. Alternatively, fan speed might be regulated according to sunlight intensity. That is, lower sunlight intensities, hence lower rates of heat input to the still, would require proportionately lower fan speeds to maintain an optimal thermal gradient. Due to the large heat capacity of the water covering the floor of the still, the maximum still temperature would be reached after noon peak solar intensity. Hence, if a photocell control circuit is employed to regulate fan speed, it is best to orient this photocell to have maximum insolation in the early afternoon. A third type of control circuit might regulate the fan speed by sensing the thermal gradient of the lower airstream at the hot end of the still, using thermistors spaced apart by 10 percent of the length of the still. If the fan speed became too slow, then the lower airstream would reach its upper temperature limit before reaching the end of the evaporator passage. The thermistors would sense the resulting low temperature difference and would increase the fan speed until a preset temperature difference was achieved.

The ASC still may also be designed so that it circulates air in an open loop. In this case, the fan blows outside air into the lower air duct at the cool end of the still, the air passes to the warm end of the still, enters the upper air duct, and returns to the cool end of the still where it exhausts to the atmosphere, instead of reentering the lower air duct. Although this open loop configuration would share many of the advantages of the closed loop design, such as multi-effect distillation, it would have the disadvantage that by exhausting warm humid air to the environment it would lose heat. With this heat no longer available to help evaporate water in the lower air duct, both the hot and cool ends of the lower air duct would shift to lower equilibrium temperatures. Since the saturation vapor pressure of air increases nonlinearly with temperature, this will result in substantially less water being distilled for the same amount of circulated air. An open loop design would be assisted if used in conjunction with the wet cooling tower of a power plant, the humidified exhaust air from the cooling tower being used as preheated air inputted to the lower air duct of the ASC still. Also, heat from the outgoing air could be partially recycled by passing the air through a heat exchanger to preheat the incoming feedstock water.

In summary, the ASC solar still differs from prior art solar stills in that it:

a) recycles a large fraction of its heat of condensation along most of the length of its evaporator section to facilitate its evaporation process,

b) establishes a thermal gradient along its length that facilitates both the evaporation and subsequent condensation of its water, and

c) places a light-transmitting condenser section over its evaporator section to retard heat loss from the evaporator and to take advantage of the normal heat flow through its roof to have this heat be lost preferentially from its condenser section.

As a result of these features, the ASC still is able to achieve a higher maximum temperature in its evaporator chamber and a higher maximum temperature differential between its evaporator and condenser temperatures with a consequent higher rate of distillation.

In addition to distilled water, the ASC still may produce shaft power or electric power as a by-product for use in operating its fan or for electric utility power generation. A condenser coil is placed in the lower air duct at the cool end of the still and an evaporator coil is placed in the upper air duct at the hot end of the still, both coils containing a working fluid. The temperature differential between the two coils would produce a pressure differential which in turn may be used to drive a turbine or heat engine which produces electrical power via an electrical generator. By amortizing the ASC still with respect to two by-products (power and distilled water) instead of one (distilled water), its economics become more competitive.

### BRIEF DESCRIPTION OF THE DRAWINGS

FIG. 1 is a cross sectional end view of a prior art greenhouse solar still.

FIG. 2 is a cross sectional side view of an advective solar collector still embodying the principles of the invention.

FIG. 3 is a perspective view of an end cross section of the still illustrated in FIG. 2.

FIG. 4 is a magnified end view of one edge of the advective solar collector still illustrated in FIG. 2.

FIG. 5 is a figure illustrating how air temperature would vary along the length of the upper and lower air ducts in an advective solar collector still.

FIG. 6 is a cut away perspective view of the still showing a pleated wick covering the floor of the still.

FIG. 7 is a cross sectional side view of the still showing sprinkler humidification.

FIG. 8 is a cross sectional side view of the still showing vertical vanes for inducing air turbulence.

FIG. 9 is a magnified end view of the left edge of an advective solar collector still that has a roof formed of two light-transmitting, flexible sheets.

FIG. 10 is a view of a solar farm composed of an array of adjacent solar still bays.

FIG. 11 is a top view of the central portion of the advective solar collector still designed to have a circular floor geometry.

FIG. 12 is an edge view of the central portion of the circular advective solar collector still shown in FIG. 11.

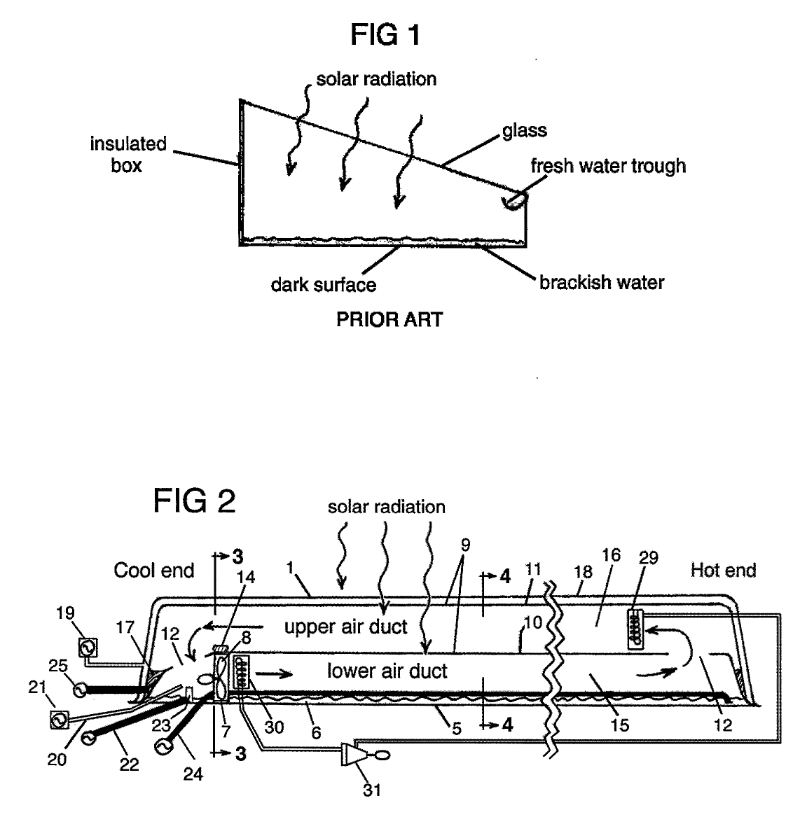

### DETAILED DESCRIPTION OF THE INVENTION

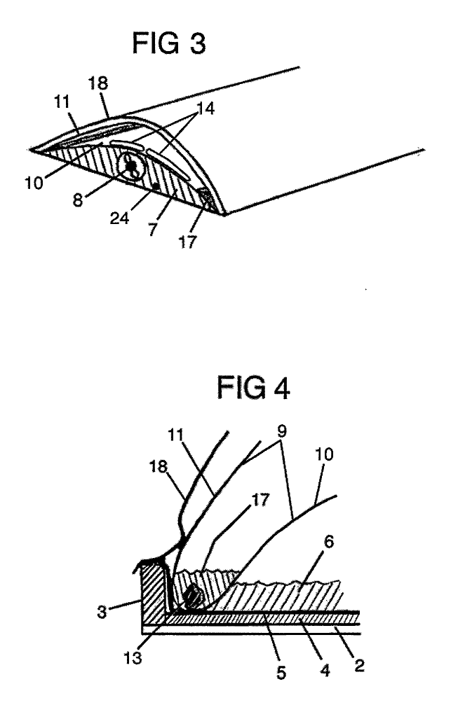

The primary embodiment of my invention is illustrated in FIG. 2, FIG. 3, and FIG. 4 which depict a practical design of a single distillation bay 1 adapted to on-site construction. The still module is tubular in shape, about ½ to 2 meters wide and 20 to 150 meters long. In one example, a bay module might measure approximately 1.1 meters wide and 30 meters long. The base of the still may be constructed by placing a series of plywood sheets 2, long-end to long-end, and nailing them to wooden beams 3, said beams being secured along the edges of the sheets so as to form an elongate basin. A sheet of insulation 4, such as high-density neoprene foam sheet or fiberboard sheet, is secured to the upper surface of the plywood and is covered with a layer of light-absorbing waterproof material 5 which extends up the sides of the edge beams. The enclosure so formed is filled with a layer of feedstock water to a depth of a few inches to form a shallow solar pond 6. Materials that could be used for the light-absorbing waterproof material include 45 mil thick EPDM (ethylene propylene diene ter polymer) membrane, butyl rubber sheet, dark silicone rubber membrane, or a heat sealable plastic such as black polyethylene film having a thickness in the range of 5 to 10 mils.

An arch-shaped barrier 7, measuring approximately 5 to 10 cm thick spans the width of the basin and is secured upright at one end of the bay. In one example, this barrier may be made from polystyrene foam. A fan 8 is mounted at the center of the barrier. A tube of light-transmitting plastic film 9, having a thickness typically in the range of 2 to 6 mils, a circumference of about 3 meters, and length about equal to the length of the basin, overlies the basin, extending horizontally along the length of the basin to display a lower layer 10 and an upper layer 11. The two ends of the plasticfilm tube are heat sealed shut and near each of these ends in the tube's lower layer 10 is a hole 12, said hole having a diameter approximately 70% of the width of the still. The edges of the tube are immersed in the solar pond at the perimeter of the basin, being weighted down with weights 13, such as smooth rocks, placed inside the tube. One end of the plastic tube is placed over the barrier 7 and is secured or sealed so that its lower layer firmly contacts the barrier's arched top. The tube may be secured either by means of a glue, by heat sealing its surface, or by placing weights within the tube such as elongated sand bags 14, pressing down the tube's lower layer 10 securely onto the barrier's upper edge. If a heat sealable plastic film is used as the light absorbing layer 5, this film would be about as wide as the basin width and would be heat sealed to the lower layer 10 of the edge of the light-transmitting plastic film tube 9 where the edge of the tube hugs the perimeter of the basin.

When operating, the fan 8 inflates plastic film tube 9 so that its lower half forms an upward arching lower layer 10 and its upper half forms an upward arching upper layer 11, as illustrated in FIG. 3. The circumference of the tube is so chosen to measures about 2 to 3 times the width of the basin, thereby allowing the tube the freedom to bow upward when inflated by the blown air. The lower film 10 constitutes a light-transmitting partition that divides the air space of the still into a lower evaporator air duct 15 and an overlying upper condenser air duct 16. The fan circulates air in a closed loop, drawing air from the upper air duct 16 and exhausting this air down the length of the lower air duct 15. Since the floor of the still is fabricated of a dark, light-absorbing material, incoming sunlight will heat the layer of feedstock water covering it. As the fan's exhausted air passes down the length of the bay's lower air duct, it becomes saturated by contact with the warmed water.

Because water is evaporating and entering the airstream, a considerable amount of heat must be transferred to the airstream in order to raise its temperature. Due to this heating time lag, or “thermal inertia,” a temperature gradient forms along the length of the still, temperature increasing in the direction of air flow. The air reaches its highest temperature at the end of the evaporator air duct, at which point, it passes through the hole in the plastic film into the upper air duct. There, it reverses its direction to travel toward the cool end of the still where the fan is located. In so doing, as the air passes down the prevailing thermal gradient, it loses heat to the tube's upper and lower film layers 10 and 11. Drops of water condense out of the airstream onto the tube's wall to collect at the tube's lower edges which are immersed in the solar pond 6. As seen in the edge detail illustrated in FIG. 4, the condensate reservoir 17 so formed lies adjacent to and is in thermal contact with the edge of the solar pond so that heat from the condensate reservoir may flow through the light-transmitting partition 10 to warm the feedstock water in the solar pond. Consequently, the surface of the condensate reservoir will be generally cooler than the upper air duct airstream and will serve as an additional surface upon which condensation takes place.

Throughout the greater portion of the still, the air in the upper condenser air duct will be warmer than the air in the lower evaporator air duct. This is due to the time lag involved in heating the air in the lower air duct and the complementary time lag involved in cooling air in the upper air duct, as illustrated in FIG. 5. Consequently, heat will conduct and radiate through the plastic film partition from the upper to the lower air duct. The condensate that collects at the edges of the plastic tube 17 will also be warmer than the adjacent pool of feedstock water 6 and as described above will transfer heat to this solar pond.

As one example, the arching lower portion 10 of the light-transmitting tube 9, when viewed in cross section, will have an arc length measuring in the range of 1.20 to 1.35 times the width of the basin, while the upper portion of the tube 11, viewed in cross section, will have an arc length measuring in the range of 1.45 to 1.65 times the width of the basin. The light-transmitting plastic tube 9 may be fabricated by heat sealing two elongate light-transmitting plastic films to one another at their outer edges, the lower film having near each of its ends a hole with a diameter equaling about 60 percent of the tube's width.

The light-transmitting tube 9 may be composed of materials such as FEP, Tefzel, Tedlar, polyetheylene, polyvinylchloride (PVC), or Mylar. FEP-L Teflon film has an expected life exceeding 20 years. Another Teflon film product called Tefzel has twice the strength of FEP, and its light transmission degrades only by about 3 percent over a 20 year time period. Tedlar, polyetheylene, PVC, and Mylar are not as attractive as Tefzel or FEP since they deteriorate under long exposure to the ultraviolet component in sunlight. Use of PVC film is discouraged for drinking water applications since this plastic contains a plasticizer which could transfer into the hot distillate and contaminate the water supply.

Teflon films such as FEP, Tefzel, or PVF have the advantage that they are hydrophobic so that water condenses on their surface in droplets rather than as a smooth film. Research has shown that dropwise condensation enhances the heat transfer process. If the film partition between the lower and upper air ducts is not inherently hydrophobic, it is advisable to apply a light-transmitting hydrophobic coating to the upper surface of the tube's lower film layer 10 to encourage droplet condensation. Also a light-transmitting hydrophilic coating may be applied to the undersides of both the lower film layer 10 and upper film layer 11 to discourage droplet formation and upward heat loss there.

To insulate the upper surface of the still and impede the upward loss of heat, it is advisable to add an additional light-transmitting insulating layer 18 to cover the upper half of the tube as shown in FIG. 2, FIG. 3 and FIG. 4. This insulating layer 18 may be made from a weather resistant heat sealable plastic film such as FEP or Tefzel Teflon film having a thickness of about 5 mils. This may be secured or heat sealed to the upper layer 11 of tube 9 on either side of the tube nearest the basin periphery. A small external blower 19 would keep this outer film inflated with dry outside air so as to form a dead air space between the two adjacent film surfaces 11 and 18. Alternatively, the insulating layer 18 may be fabricated of a light-transmitting stiff, flexible sheet made of plastic or fiberglass that is sprung against the sides of the basin to form an arched tunnel. In one example, this flexible sheet might be composed of 40 mil Sunlite® fiberglass sheet produced by the Kalwall Corp., Manchester, N.H. Such a flexible sheet would have the advantage of better protecting the still from external mechanical damage and also of being self supporting without the need for a separate external air blower. However, due to UV absorption, such sheets would deteriorate and need to be replaced more frequently than if teflon film were used. Fiberglass sheet, for example, yellows and develops visible fraying of its outer surface. Additional light-transmitting canopies may be added to create additional dead air spaces for better insulation and higher operating temperatures. If plastic film is used, these added layers may be kept inflated by the same blower.

To prevent a low pressure from forming in the air space directly behind the fan, the still incorporates an air vent tube 20, typically about 2 cm in diameter, communicating from behind the fan to the outside atmosphere. This ensures that a positive pressure with respect to atmospheric will be maintained throughout the still when the fan is operating and that the structure of the still will remain inflated. Hence, the fan serves two purposes: a) to advect air down the length of the lower and upper air passages and b) to inflate these air passages. In the case where the fan is turned off during the night to conserve power, the structure may be kept inflated by an auxiliary high-pressure-drop external blower 21 attached to the air vent tube. If necessary, the solar pond may be bridged by a series of arching struts or hoops so as to prevent the lower film layer 10 from collapsing onto the water surface during such shut-off periods.

Feedstock water is admitted into the still through an inlet pipe 22 which discharges to the cool end of the feedstock water pool 6. A float valve 23 admits feedstock water to the still whenever the water level in the still's water pool drops too low. To prevent salt deposits from building up, the concentrated brine at the hot end of the still is periodically removed. The hot brine is slowly pumped from the hot end of the still through a thermally conductive pipe 24 lying along the floor of the feedstock pool and conveying its water to the cool end of the still where it exits the still. In this manner, the feedstock concentrate (e.g. brine water) may give up most of its heat to the feedstock water covering the floor of the still. For every 10 liters or so of water that is distilled, about one liter of feedstock concentrate may be thus removed. As a practical example, this conductive tube may consist of a plastic garden hose. Brine removal may be scheduled for night time hours to minimize heat loss from the still. Finally, fresh water condensate 17 is pumped from the edges of the upper air duct through a fresh water outlet pipe 25 that exits at the cool end of the still.

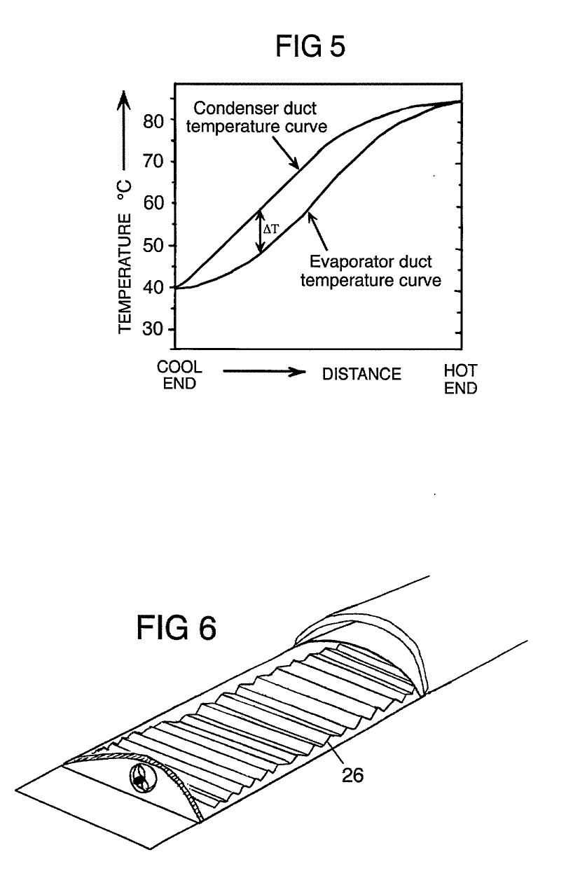

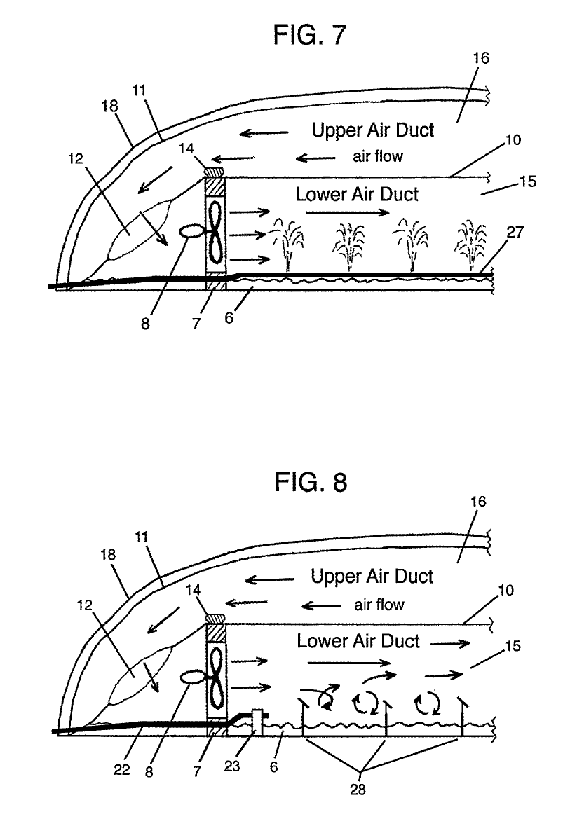

Humidification of the lower airstream may be enhanced by covering the floor of the still with a light-absorbing pleated wick 26, as shown in FIG. 6. This wick may be made of a water-absorbing fabric and arranged such that its pleats dip into the feedstock water. Thus, air blowing over the wet fabric encounters a greater surface area for evaporation. Alternatively, referring to FIG. 7, humidification may be enhanced by spraying the input feedstock water into the airstream along the length of the evaporator chamber. One way this could be done is by pumping this water through a perforated plastic sprinkler hose 27 of the sort that is used to sprinkle water on lawns.

The humidification and condensation processes may also be improved by increasing the amount of airstream turbulence since turbulence increases the rate of heat transfer between the airstream and surrounding surfaces, thereby assisting heat transfer from the upper to the lower air duct. As one example, if the air passage has a perimeter of 3 meters and if air is advected through it at a speed of 0.1 m/sec, the air flow will have a Reynolds number of 17,000 characteristic of turbulent flow, laminar flow becoming turbulent for Reynolds numbers above 10,000. Higher fan speeds will produce greater airstream turbulence and greater rates of heat transfer. However, excessively high fan speeds would have the disadvantage that the increased air flow resistance would place a greater power demand on the fan. Turbulence may also be increased by using two adjacent fans, rather than a single fan, to blow air through the air ducts. In addition, turbulence may be increased by placing in the lower air duct a series of elongated vanes 28 oriented crosswise so as to deflect the air flow either upward or downward, see FIG. 8.

An evaporator heat exchanger coil 29 is situated in the upper air duct near the hot end of the still so that heat from the advected air will evaporate its contained working fluid liquid and assist in condensing water from the airstream. Also a condenser heat exchanger coil 30 is situated in the lower air duct near the cool end of the still downstream of the fan 8 so that heat released from condensation of its contained working fluid vapor will be transferred to the advected air and assist in evaporating feedstock water. These heat exchangers are connected via pipes to a turbine or heat engine 31 so that the pressure differential of their working fluid may be harnessed to provide shaft power for generating electricity. This shaft power or electrical power may in turn be used to actuate the fan 8 or to provide surplus electrical power for a nearby utility grid.

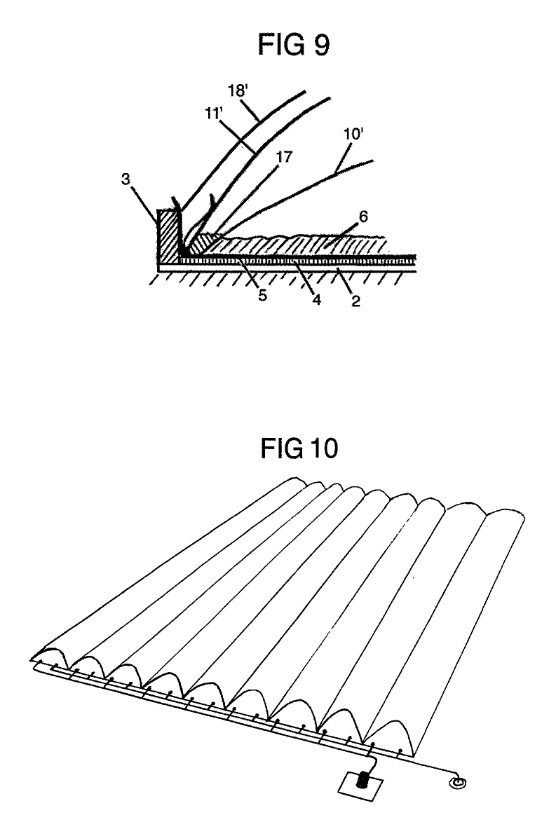

Referring to FIG. 9, in another embodiment of the still, two light-transmitting, stiff, flexible sheets 11′ and 18′ would replace the upper light-transmitting plastic film layers 11 and 18 of the condenser air duct. The edges of the flexible sheets would be sprung against the basin curb boards to form arches separated from one another by a dead air space. This would leave a single light-transmitting plastic film 10′ to serve as the partition between the evaporator and condenser air ducts. The edges of this film would be sealed to the edges of the flexible sheet at opposite sides of the solar still bay.

As illustrated in FIG. 10, many elongated ASC still bays may be placed side by side to form a rectangular solar still farm. Also several such farm arrays may be placed end to end. Such solar still farm arrays may be designed so that the evaporator and condenser heat exchangers of adjacent still bays are brought into close proximity with one another, the hot end of one still bay being situated near the cool ends of an adjoining bay.

In addition to being designed to lie flat along the ground, the ASC still bays may also be designed to be oriented vertically along the wall of a building. In the application for distillation, the hot end of the still would be at the highest elevation and cool end of the still at the lowest elevation. In this way, the chimney effect would aid transport of the air up the evaporator chamber and then down the condensing chamber. The feedwater to be distilled would be pumped to the top of the still (hot end) and sprayed onto a black light-absorbing wick surface and allowed to slowly drip downward. This wick would be made of absorbent material such as felt or cloth.

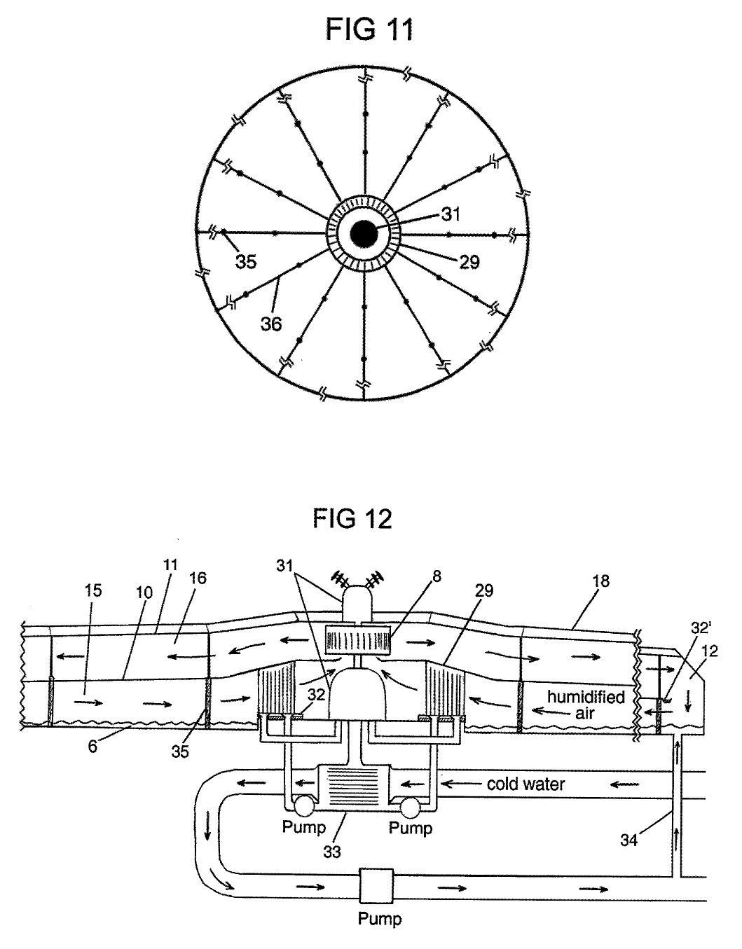

In another embodiment of the disclosed invention, the ASC still may be designed to have a circular, rather than a rectangular footprint geometry. Referring to FIG. 11 and FIG. 12, a circular shallow solar pond 6 having a light-absorbing floor 5 is covered by light-transmitting plastic film layers 11 and 18 spaced from one another by approximately 5 centimeters. These films are joined together at their edges form an intervening insulating inflatable air space. An intermediate light-transmitting layer 10 is situated between light absorbing floor 5 and light-transmitting layer 11, dividing the still's interior air space into lower 15 and upper 16 air spaces or air ducts. A high-volume blower 8 with an attached power plant turbine-generator 31 is located at the geometrical center of the still. The blower draws heated and humidified air from the lower evaporator air duct causing air to flow radially inward from the cool periphery of the still to its hot center. Said air is warmed and humidified as it passes over the surface of the shallow solar heated pond of feedstock water. The humidified air then passes through the power plant's evaporator heat exchanger coil 29 which is centrally situated in a ring around the central blower. As the air passes through this coil a portion of its water vapor condenses and is gathered in an underlying fresh water collection trough 32. The blower exhausts its air into the upper air duct where further water condensation occurs as the air passes from the hot center to the cooler periphery of the still. By designing the still so that light-transmitting layer 10 slopes from the center of the still downward toward the periphery of the still condensate may be induced to run off into a collection trough 32′ girdling the periphery of light-transmitting layer 10. Condensate from troughs 32 and 32′ is removed from the periphery of the still via a network of pipes. Upon reaching the still's periphery, the airstream reenters the lower air duct through a connecting edge air passage 12 that extends around the periphery of the still, the width of this passage being comparable to the height of the upper or lower air duct. The power plant condenser coil 33 is cooled by pumping cooling water from a nearby water source. A portion of the outflow is diverted to the floor of the solar still via pipe 34 to supply preheated water to the solar pond. The light-transmitting plastic film layers 10, 11, and 18 are supported at periodic intervals by a series of tent poles 35 and cables 36 designed to keep the films erect against the positive pressure force applied to the upper air duct. These poles would be of sufficient length to space this layer from the feedstock water basin so as to allow a sufficient space for air flow. As in the previously described embodiment, brine would be conducted via a pipe to the cool end of the still where it would be continuously removed.

The prior art solar stills of Beard, Dobell, and the non-prior art still of ElDifrawi et al. (U.S. Pat. No. 4,363,703) are similar to the presently described Advective Solar Collector still to the extent that they also utilize forced air circulation to transport humidified air from an evaporator to condenser air duct. However, these stills differ from the ASC still in that their evaporator and condenser air ducts are not juxtaposed and sharing a thermally conductive wall along their length, nor are thermal gradients established along the length of the air ducts to assist heat flow from the evaporator to the condenser. These prior art designs are essentially single-effect solar stills. One version of the Dobell design does have evaporator and condenser air ducts that are juxtaposed and sharing a common wall, but this wall is not made of a thin film or of thermally conductive material that would allow heat to transfer at an appreciable rate from the condenser airstream to the evaporator airstream. The condenser chamber air duct is described as a vertical pipe positioned within, and concentric with, a vertical cylindrical evaporator chamber, the ducts being so arranged to take advantage of the chimney effect. That is, the tendency for heated air to rise would assist upward air transport in the outer, evaporator duct and the tendency for cooled air to sink would assist downward air transport in the inner condenser chimney.

The idea of a solar still that incorporates air inflated plastic film ducts as its entire structure, or as a major portion of its structure, is a novel feature of this invention. This has the advantage of allowing the still to be made portable for use in remote locations where a temporary supply of water is needed during a period of drought or other emergency. F. Rom has patented an inflatable single-pass solar air heater in 1975 (U.S. Pat. No. 3,908,631). According to this design, a fan was made to blow air down a long plastic film tube which had a light-transmitting upper layer and a black solar absorbing lower layer. During its passage down the length of the tube, the air was heated by contact with the hot floor of the tube and would exit at the far end of the tube where it would provide a source of hot dry air for some application such as for ventilating a grain elevator. This design also made use of a second light-transmitting film overlying the first and inflated above it so as to provide extra thermal insulation for retaining heat within the solar collector. G. Benjamin also patented a single-pass, inflatable solar air heater in 1984 (U.S. Pat. No. 4,458,673) (non-prior art). According to this variation, air is blown through a black central plastic air duct surrounded by a second inflated tube that is transparent on its upper surface and reflective on its lower surface. However, the Rom and Benjamin solar air heaters were not designed for the purpose of water distillation. Consequently, unlike the ASC still, these designs do not humidify their airstream. Also they do not reverse the air flow at the hot end of their air ducts so as to direct the flow back toward the cool end of their ducts so as to facilitate heat exchange between juxtaposed air ducts.

The non prior art solar still of Mink et al. (1998) is similar to the presently disclosed ASC still to the extent that it also utilizes forced air circulation to transport humidified air from an evaporator air duct to an adjacent condenser air duct which are in thermal contact with one another. However, the two stills differ in that the ASC still positions its condenser air duct above its evaporator air duct, instead of below this duct. Also the ASC still separates its evaporator and condenser air ducts by means of a thin film transparent barrier, rather than by an opaque metal sheet. Furthermore a bay of the ASC still is much longer than it is wide, its length-to-width ratio typically being greater than 10, whereas the solar still of Mink et al. has a length-to-width ratio of approximately 3. As a fourth difference, the ASC still in its more efficient configuration circulates its air in a closed loop, whereas the solar still of Mink et al. circulates its air in an open loop.

The ASC still has several advantages over the solar still of Mink et al. First, by placing the condenser air duct above the evaporator air duct, the ASC design minimizes upward heat loss from its evaporator chamber, the warm humid air and condensate in the overlying air duct impeding infrared radiation from escaping upward and leaving from the evaporator. The still of Mink et al., on the other hand, relies solely on the insulating effect of its double glazed transparent cover to impede heat flow from its evaporator. By locating its condenser air duct over its evaporator air duct, the ASC still makes use of the tendency for heat to naturally escape through the roof of the still. This upward heat loss helps to condense water from the upper air duct air stream and is instrumental in creating the thermal gradient along the length of the air duct. Yet another advantage of the ASC still is that, being made for the most part of plastic film, its cost per unit area is much less than that of the still of Mink et al.

As mentioned earlier, the considerable length of the ASC still air ducts allows them to establish a large temperature differential between their opposite ends when air is passing through them. A substantial air path length is necessary in order to allow sufficient time for the blown air to effect a substantial change of temperature by either absorbing or discharging heat. Moreover, by making thermal exchange barrier 10 out of a nonmetallic transparent substance such as plastic film, which has low thermal conductivity per unit thickness, a minimum amount of heat will be lost through wall conduction from the hot to the cool end of the still, thereby allowing maximal temperatures to be maintained at the still's two extremities. The air flow path in the still of Mink et al., however, is rather short, being only about 2 meters in length. Also that still uses a sheet of copper as a thermal exchange barrier between its evaporator and condenser, with this barrier being in direct contact with its pool of feedstock water. The short length of the Mink et al. still and its use of a relatively high thermal conductivity surface in its wall structure both serve to reduce the magnitude of the temperature gradient that the still is able to establish along the length of its air ducts. For example, measurements show that at its optimal air flow rate the Mink et al. solar still develops a temperature differential of only about 3 to 4° C. over 80% of its air duct length. By comparison, a 20 meter long ASC still would be able to achieve a temperature differential of at least 45° C. between its cool end and hot ends. With its large temperature differential, the ASC still is able to take advantage of the heating and cooling time lag of its advected air to develop a large temperature differential between the evaporator air stream and its adjacent condenser air stream, this upper-to-lower air duct temperature differential reaching as high as 10° C. over most of the length of the still. By comparison, in the still of Mink et al. there is essentially no temperature differential between the evaporator and condenser air ducts over 80 percent of their contact length. Heat transfer in that still occurs primarily over about 20 percent of the air duct length where cool outside air enters the evaporator duct depressing its temperature about 5° C. relative to that of the condenser air duct. Consequently, the ASC design more effectively recycles its heat of condensation for reuse in feedstock water evaporation.

It should be understood that the foregoing disclosure emphasizes certain specific embodiments of the invention and that all modifications or alternatives equivalent thereto are within the spirit or scope of the invention as set forth in the appended claims.

What is claimed is:

1. A solar energy collecting assembly comprising, in combination, at least one elongate solar energy collector bay, the floor of the collector bay constituting a first elongate layer with a generally flat level surface fabricated of a solar energy absorbing material, said first layer being overlain by a second elongate layer with a light-transmitting flexible film extending along the length of the solar collector floor and secured or sealed at the floor's perimeter so as to form a first airtight enclosure termed the lower air duct, said second layer being overlain by a third elongate layer comprising a light-transmitting material extending along the length of the solar energy collector bay and secured or sealed at the perimeter of the second layer so as to form a second overlying airtight enclosure termed the upper air duct, the second layer further having openings at each of its ends to allow air to freely communicate between the upper and lower air ducts, the solar energy collector bay further having means for admitting a fluid, such as water, into the lower air duct and a means for removing the fluid condensate from the upper air duct, a means for providing a flow of air and vapor through said air ducts, air and vapor being made to flow through the upper air duct in a direction opposite to the direction it is made to flow through the lower air duct, said air flow means propelling air and vapor at a rate that establishes a temperature gradient along the length of the solar energy collector bay such that one end of the solar collector bay is made warmer than the other end.

2. The solar energy collector bay of claim 1 wherein said second and third elongate layers are fabricated of light-transmitting plastic film.

3. The light-transmitting plastic film of claim 2 where said film has a thickness in the range of 1 to 8 mils.

4. The light-transmitting plastic film of claim 2 where said plastic has hydrophobic characteristics.

5. The light-transmitting plastic film of claim 2 where the surfaces of said film are covered with a hydrophobic coating.

6. The solar energy collector bay of claim 1 wherein said second and third elongate layers are of a width such that they form two arched air ducts, one overlying the other, extending along the length of the solar collector.

7. The solar energy collector bay of claim 1 wherein the floor of said collector bay is fabricated of solar energy absorbing plastic film and is secured or sealed to the perimeter of said second elongate layer so as to form an airtight enclosure termed the lower air duct.

8. The solar energy collector bay of claim 1 wherein said air flow means propels air at a rate that establishes a temperature gradient along the length of said collector bay such that each end of the collector has a temperature difference in the range of 5 to 60 degrees C.

9. The solar energy collector bay of claim 1 wherein said air flow means is an electric fan situated inside the solar energy collector bay.

10. The fan of claim 9 where the electric circuit powering said fan includes either temperature sensors for sensing the temperature differential along the length of the still, a photosensitive device for sensing the ambient level of incident solar radiation, or a clock timer.

11. The solar energy collector bay of claim 1 wherein said lower air duct includes an air passage that allows outside air to communicate with the interior of the duct at a point close to the fan air intake.

12. The solar energy collector bay of claim 1 wherein said third elongate layer is overlain by a fourth elongate layer comprising a light-transmitting material extending along the length of the solar collector and secured or sealed at the perimeter of the third layer so as to form an airtight insulating space overlying the upper air duct.

13. The fourth elongate layer of claim 12 wherein said layer is fabricated of light-transmitting plastic film.

14. The airtight insulating space of claim 12 incorporating an air passage communicating with the outside air for inflating said insulating space, and further including seal means such that air admitted to said insulating space may be confined therein.

15. The fourth elongate layer of claim 12 wherein said layer is fabricated of a translucent fiberglass sheet or a light-transmitting glass pane.

16. The solar energy collector bay of claim 1 wherein said third elongate layer is fabricated of a translucent fiberglass sheet or a light-transmitting glass pane.

17. The solar energy collector bay of claim 1 wherein said means for admitting a fluid includes a means for spraying this fluid up into the airstream of the lower air duct along the length of said air duct.

18. The solar energy collector bay of claim 1 wherein the floor of said solar collector bay is overlain with a pleated, fluid-absorbing wick fabricated of a solar energy absorbing material.

19. The solar energy collecting assembly of claim 1 where said assembly comprises a series of adjacent solar energy collector bays.

20. The solar energy collector bay of claim 1 wherein said lower air duct contains a condenser heat exchanger coil at its cool end and said upper air duct contains an evaporator heat exchanger coil at its warm end, said condenser and evaporator coils containing a working fluid which provides a pressure differential useful for extracting mechanical power.

21. The solar energy collecting assembly of claim 1 wherein said air flow means is situated outside the solar energy collecting assembly in a cooling tower that includes a condenser heat exchanger coil, the exhaust from this cooling tower being ducted to the solar energy collecting assembly and made to enter the cool end of the lower air duct of one or more solar energy collector bays, the warm end of the upper air ducts of said bays containing evaporator heat exchanger coils, air at the cool end of the upper air ducts of said bays being exhausted to the atmosphere, said condenser and evaporator coils containing a working fluid which provides a pressure differential useful for extracting mechanical power.

22. The solar energy collecting assembly of claim 1 wherein said solar energy collector bay is oriented vertically with the warm end of the collector bay being at the top, said means for admitting a fluid including means for pumping the fluid to the upper end of the lower air duct and spraying it onto the surface of a fluid-absorbing, solar energy absorbing wick layer covering the floor of the collector bay.

23. A method for generating a temperature differential along the length of an elongate solar collector bay, by providing a light-transmitting partition for dividing the interior air space of said bay into upper and lower air ducts, admitting a fluid such as water into the cool end of the lower air duct, removing condensate from the cool end of the upper air duct, and providing a means for advecting the vapor saturated air so that it passes from the cool to the warm end of the lower air duct, then enters the upper air duct and reverses its direction to pass from the warm to the cool end of that duct.

24. A solar energy collecting assembly for distilling water and generating power comprising:
an elongated roof means for allowing transmission of sunlight,
an elongated floor means for absorbing sunlight fixedly attached to and situated below said roof means, together forming an interior air space,
an elongated light-transmitting sheet means for partially separating said interior air space into an upper elongated air space and a lower elongated air space while fixedly attached between said roof means and said floor means and having an opening at either end that connects the upper and lower air spaces,
a means for circulating air through the interior air space so that it passes down the length of the lower elongated air space, through one of said end openings in the transparent sheet means, down the length of the upper elongated air space, and then through the other of said end openings in the transparent sheet means, said circulating means propelling air with sufficient velocity so as to induce elongated thermal gradients along the lengths of said upper and lower air spaces with sufficient temperature differential to induce the progressive evaporation and subsequent progressive condensation of water,
a control means for regulating the speed of the circulating air means,
a forcing means forcing water to flow through said lower air space,
a removal means for removing the water condensate from said upper air space,
a first heat exchanger means for extracting heat from the hotter end of the elongated thermal gradient with the use of an internal working fluid to perform useful work,
a second heat exchanger means for releasing heat from said working fluid toward the cooler end of the elongated thermal gradient.

25. A solar energy collecting assembly for distilling water and generating power comprising:
a roof means for allowing transmission of sunlight,
a floor means for absorbing sunlight situated below said roof means and spaced from said roof means so that the two surfaces enclose an interior air space,
a forcing means forcing water to flow over said floor means,
a light-transmitting sheet means for separating said interior air space into an upper air space and a lower air space said light-transmitting sheet means having first and second openings each connecting said upper and lower air spaces so as to allow the free flow of air between them, said first opening being situated near the geometrical center of said solar energy collecting assembly and said second opening being situated near the periphery of said solar energy collecting assembly,
a circulating means for circulating air through the interior air space so as to induce air to flow through said lower air space from the periphery to the center of said solar energy collecting assembly, to then pass through said first opening into said upper air space, to then travel through said upper air space in a reverse direction from the center to the periphery of said solar energy collecting assembly, and then to pass through said second opening into said lower air space, said circulating means propelling air with sufficient velocity so as to induce an extended thermal gradient within said solar energy collecting assembly, said thermal gradient having its hotter end near said first opening, its cooler end near said second opening, and having a temperature differential sufficient to induce the progressive evaporation of water in said lower air space and progressive condensation of water in said upper air space,
a control means regulating the speed of said circulating means,
a removal means removing water condensate from said upper air space,
a first heat exchanger means extracting heat from air or water within said interior air space at a location near the hotter end of said extended thermal gradient, said first heat exchanger means containing an internal working fluid used to perform useful work,
a second heat exchanger means for releasing heat from said working fluid to air or water within said interior air space at a location near the cooler end of said extended thermal gradient.
